(19) United States
(12) Patent Application Publication
(10) Pub. No.: US 2026/0116134 A1
(43) Pub. Date: Apr. 30, 2026

(54) Trailer Lock

(71) Applicant: Moovalot, LLC, Houston, TX (US)

(72) Inventors: Robert Michael Villarreal, Houston, TX (US); DeAngelo Rios, San Antonio, TX (US)

(73) Assignee: Moovalot, LLC, Houston, TX (US)

(21) Appl. No.: 19/375,900

(22) Filed: Oct. 31, 2025

Related U.S. Application Data
(60) Provisional application No. 63/714,276, filed on Oct. 31, 2024.

(51) Int. Cl. B60D 1/60; B60R 25/01; B60R 25/102

(52) U.S. Cl. CPC B60D 1/60; B60R 25/01; B60R 25/102

(57) ABSTRACT

The present disclosure is directed to methods and apparatuses for securing trailers. The device is a remote-controlled locking mechanism designed for securing a trailer hitch. It operates via an electric lock actuator connected to a digital application, allowing users to control the locking and unlocking function remotely.

### CROSS REFERENCE TO RELATED APPLICATIONS

This application claims priority to and the benefit of U.S. Prov. Pat. App. Ser. No. 63/714,276, which was filed on Oct. 31, 2024, and is hereby incorporated herein by reference in its entirety for all purposes, including the right of priority.

### TECHNICAL FIELD

The present disclosure relates generally to the field of trailers and, more particularly, to methods and apparatuses for securing trailers.

### BACKGROUND

This section of this document introduces information about and/or from the art that may provide context for or be related to the subject matter described herein and/or claimed below. It provides background information to facilitate a better understanding of the various aspects of the claimed subject matter. This is a discussion of “related” art. That such art is related in no way implies that it is also “prior” art. The related art may or may not be prior art. The discussion in this section of this document is to be read in this light, and not as admissions of prior art.

Vehicles in ground transportation frequently tow trailers to carry loads that the vehicle cannot carry itself or for other logistical purposes. Vehicles and trailers in these scenarios come in a wide range of types, sizes, and purposes. For example, a motorcycle may tow a small, two-wheeled trailer or a semi-truck may tow a large trailer in a configuration frequently called an “18 wheeler”. There are many variations on this theme. The type of “hitch” by which the trailer is structurally engaged, or connected, to the vehicle may vary depending on a number of factors including not only the type of vehicle and the type of trailer, but also the type, weight, and size of the load.

One aspect of owning or using a trailer is the desire or need to secure it. Trailers are often targets of theft, either because their presumed contents are valuable or because the trailers themselves are valuable. Trailers are also frequently used on public roadways and all modes of transportation on public roadways require care and attention for safe and proper handling and travel. Trailers should therefore be secured accordingly.

### SUMMARY

The present disclosure is directed to methods and apparatuses for securing trailers. The device is a remote-controlled locking mechanism designed for securing a trailer hitch. It operates via an electric lock actuator connected to a digital application, allowing users to control the locking and unlocking function remotely.

In a first aspect, a trailer lock comprises a locking mechanism and a programmable electronic trailer lock controller. a programmable electronic trailer lock controller, in turn, comprises a communications interface and a processor-based resource. The trailer lock controller receives lock and unlock signals to and from off-trailer through the communications interface. The processor-based resource programmed to issue lock and unlock controller commands to the locking mechanism responsive to received lock and unlock signals.

In a second aspect, a method for use in locking a trailer connection comprises receiving an off-trailer signal to lock or unlock a locking mechanism structurally engaged with a trailer and issuing a lock or unlock controller command to the to the locking mechanism responsive to received lock and unlock signals.

In a third aspect, a trailer security system comprises a trailer lock, a computing system, and an off-trailer, cloud-based controller. The off-trailer, cloud-based controller transmits lock and unlock signals to the trailer lock over the computing system.

In a fourth aspect, a method for securing a trailer comprises transmitting lock and unlock signals from an off-trailer, cloud-based controller to a trailer lock of the trailer and locking and unlocking a trailer lock of the trailer responsive to the lock and unlock signals.

The above presents a simplified summary in order to provide a basic understanding of some aspects of what is claimed below. This summary is not an exhaustive overview of the claimed subject matter. It is not intended to identify key or critical elements of the disclosure or to delineate the scope of the claims. Its sole purpose is to present some concepts in a simplified form as a prelude to the more detailed description that is discussed below.

### BRIEF DESCRIPTION OF THE DRAWINGS

The detailed description is made with reference to the accompanying drawings and is provided to assist in a comprehensive understanding of various example embodiments of the present disclosure. Changes may be made in the function and arrangement of elements discussed without departing from the spirit and scope of the disclosure. Various embodiments may omit, substitute, or add various procedures or components as appropriate. For instance, features described with respect to certain embodiments may be combined in other embodiments. In addition, descriptions of well-known functions and constructions may be omitted for clarity and conciseness. Accordingly, those of ordinary skill in the art will recognize that various changes and modifications of the examples described herein can be made without departing from the spirit and scope of the present disclosure.

FIG. 1 depicts an embodiment of the trailer lock installed on a trailer in accordance with one or more embodiments.

FIG. 2A and FIG. 2B depict the trailer lock installation of FIG. 1 in a first bottom view and a second bottom view, the two views being from different perspectives.

FIG. 3A, FIG. 3B, and FIG. 3C depict the mounting plate, the electronics locker storing the electronics of the trailer lock controller in a first view, and the electronics locker in a second view, respectively, as first shown in FIG. 1.

FIG. 4A, FIG. 4B, FIG. 4C, FIG. 4D, and FIG. 4E depict the locking mechanism of the trailer lock in left-hand, right-hand, top, front, and back views in accordance with one or more embodiments.

FIG. 5 depicts a sample coupler as may be used in one or more examples.

FIG. 6 depicts a scenario in which a trailer security system may be implemented according to one or more examples.

FIG. 7A, FIG. 7B, and FIG. 7C are block diagrams of selected aspects of the trailer lock controller, the off-trailer, cloud-based controller, and the remote device, respectively, first shown in FIG. 6.

While the disclosed subject matter is susceptible to various modifications and alternative forms, the drawings illustrate specific implementations described in detail by way of example. It should be understood, however, that the description herein of specific examples is not intended to limit that which is claimed to the particular forms disclosed, but on the contrary, the intention is to cover all modifications, equivalents, and alternatives falling within the spirit and scope of the appended claims.

### DETAILED DESCRIPTION

Selected components of a trailer lock include a locking rod, a detention rod, an electric lock actuator, a lock body, a lock motion and locator, a metal lock pin, a detention screw, electrical wiring, and some mounting feet. The locking rod includes a position indicator that indicates the lock's engagement status, showing whether the lock is in a secure or open position. The detention rod ensures the locking rod remains in position, preventing unauthorized movement. The electric lock actuator powers the locking and unlocking process remotely via a user-controlled app, facilitating secure remote operation. The lock body is the main housing structure of the mechanism that supports the internal locking components. The lock motion and locator guide the movement of the lock, ensuring precise positioning when securing the hitch. The metal lock pin and detention screw secure the hitch by inserting into the locking area; the detention screw provides added stability to prevent accidental unlocking. The electrical wiring connects the electric components within the lock mechanism. The mounting feet provide stable installation points for attaching the lock to the trailer hitch.

In operation, once the locking mechanism is mounted onto the trailer hitch, the electric lock actuator is activated through a mobile app. The app sends a signal to the actuator, which engages the locking rod and metal lock pin to secure the trailer hitch in place. A position indicator displays the locking status, allowing users to confirm secure engagement remotely.

Note that, in the following discussion, the disclosed trailer lock does not necessarily lock the mechanical engagement of the trailer with the towing vehicle. While it may, it may also lock the mechanical disengagement with the towing vehicle. That is, the trailer lock locks the state of the mechanical engagement between the trailer and the towing vehicle.

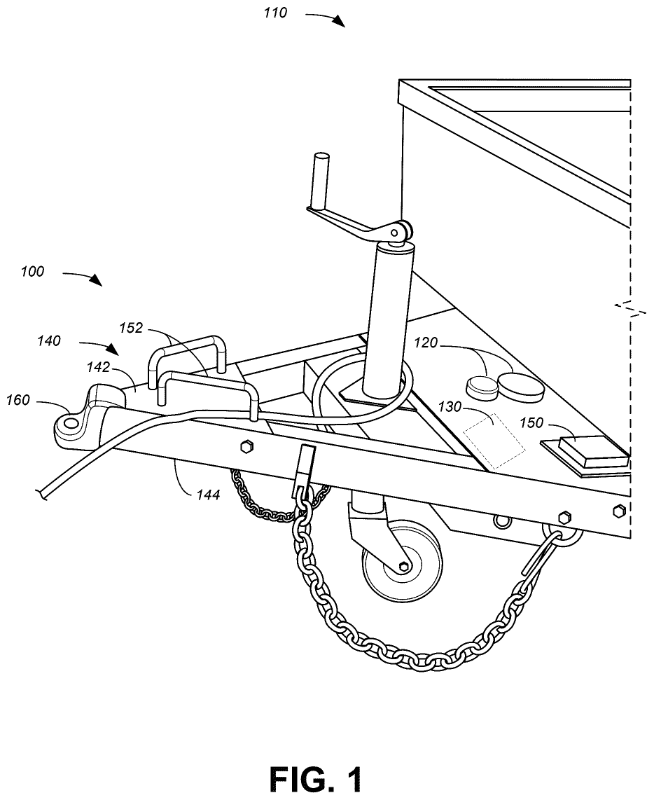

Turning now to the drawings, FIG. 1 depicts an embodiment of the trailer lock installed on a trailer in accordance with one or more embodiments. In particular, FIG. 1 is a top, perspective view of a trailer tongue 100 by which a trailer 110 may be hitched to a tow vehicle (not shown). Visible in FIG. 1 are a communications antenna 120, an electronics locker 130, a coupler lock 140, and a pair of handles 152 by which the trailer tongue 100, and thereby the trailer 110, may be maneuverable. Also shown is a ventilation feature 150. The coupler lock 140 is secured to the trailer tongue 100 by welding or otherwise affixing the plate 142 to the rails 144 of the trailer tongue 100. The coupler lock 140 includes an internal lock mechanism discussed further below mounted to the underside of the plate 142. The internal lock mechanism interacts with the coupler 160 to secure the trailer in a manner also discussed further below.

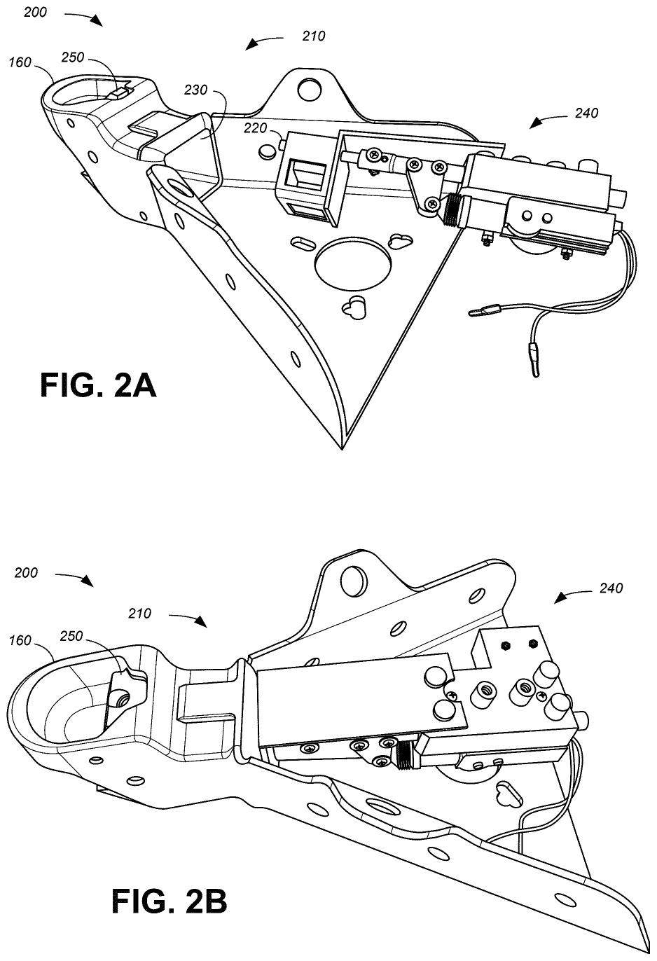

FIG. 2A and FIG. 2B are a bottom, perspective views of a portion 200 of the trailer tongue 100, shown in FIG. 1. The views in FIG. 2A, 2B depict the trailer lock installation 210 of FIG. 1 in a first bottom view and a second bottom view, the two views being from different perspectives. In FIG. 2A, the trailer lock installation 210 is shown in an unlocked position and the lock pin 220 and the hitch locking area 230 are best shown. The internal lock mechanism 240 and the trailer lock slide 250 are best shown. In use and in the locked position, the trailer lock slide 250 will engage the underside of a hitch ball to lock the trailer to the tow vehicle.

In use, the trailer lock slide 250 is spring loaded and reciprocates horizontally as the coupler 160 is mounted over and onto the ball (not shown) of a hitch. The internal lock mechanism 240 drives the lock pin 220 forward in the lock position to prevent the trailer lock slide 250 from reciprocating to permit the coupler 160 from being lifted onto or off the bal. The internal lock mechanism 240 retracts the lock pin 220 in the unlock position to permit the trailer lock slide 250 to move onto or off the ball.

Accordingly, when the coupler 140 is mounted to the ball of a hitch and the internal lock mechanism 240 is in the lock position, the locked trailer slide 250 will not slide to permit the coupler 140 to be removed from the ball. This helps secure the trailer to the tow vehicle while in transit and inhibits undesirable activity relative to the trailer, such as theft. When the couple is not mounted to the ball and the internal lock mechanism 240 is in the lock position, the locked trailer slide 250 will not permit the coupler 140 to be mounted to a ball. This also inhibits nefarious activity such as theft by which an unauthorized party may attempt to hitch the trailer to their own tow vehicle. Conversely, when the internal lock mechanism 240 is in the unlocked position the coupler 140 may be freely mounted to and removed from the ball of a hitch.

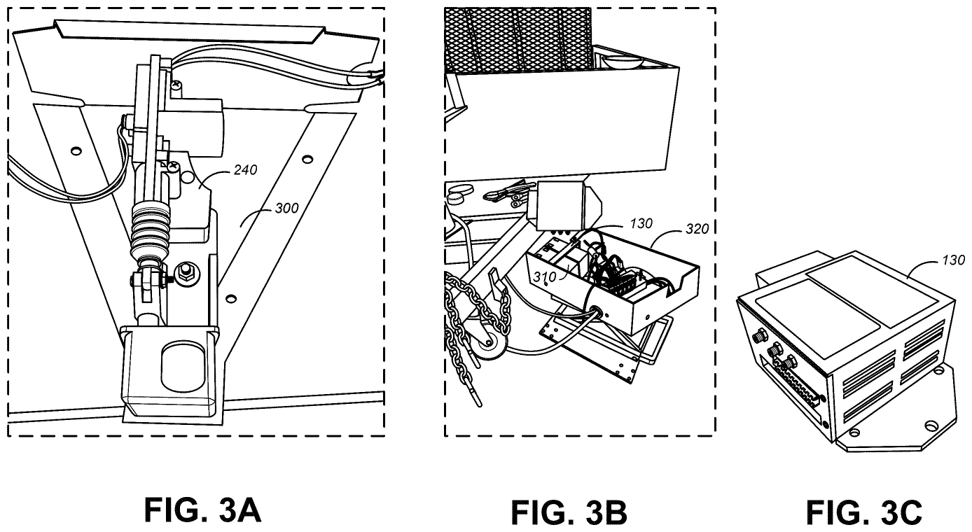

FIG. 3A, FIG. 3B, and FIG. 3C depict the mounting plate 300 and the electronics locker 130 in a first view in FIG. 3B, and in a second view in FIG. 3B, respectively. The electronics locker 130, as first shown in FIG. 1, stores the electronics of the trailer lock controller as discussed further below. The electronics locket 130 may also be referred to as the command module enclosure. Also shown are a battery pack 310 and an equipment locker 320.

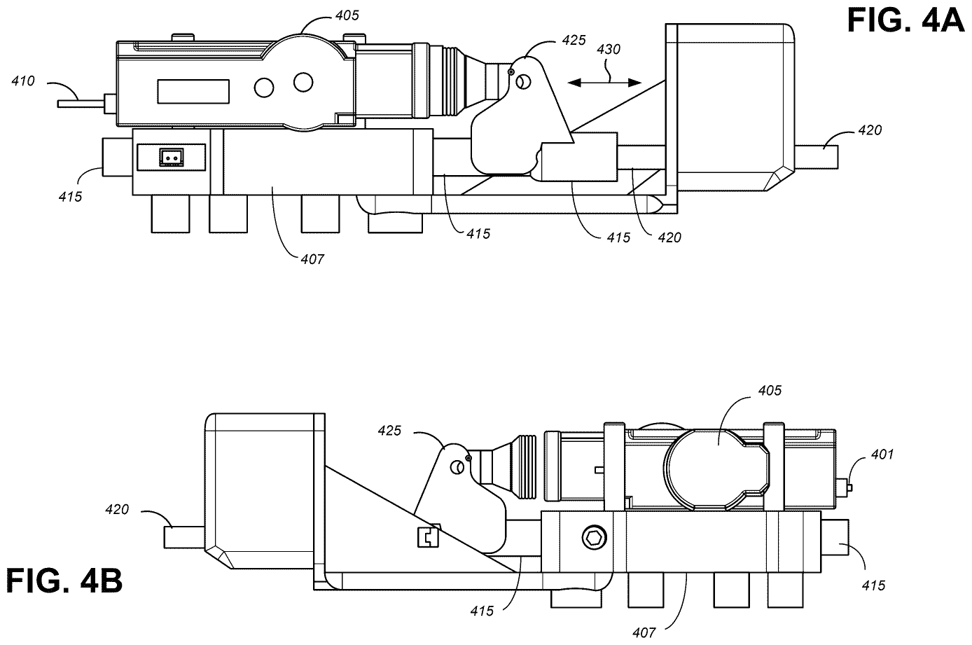

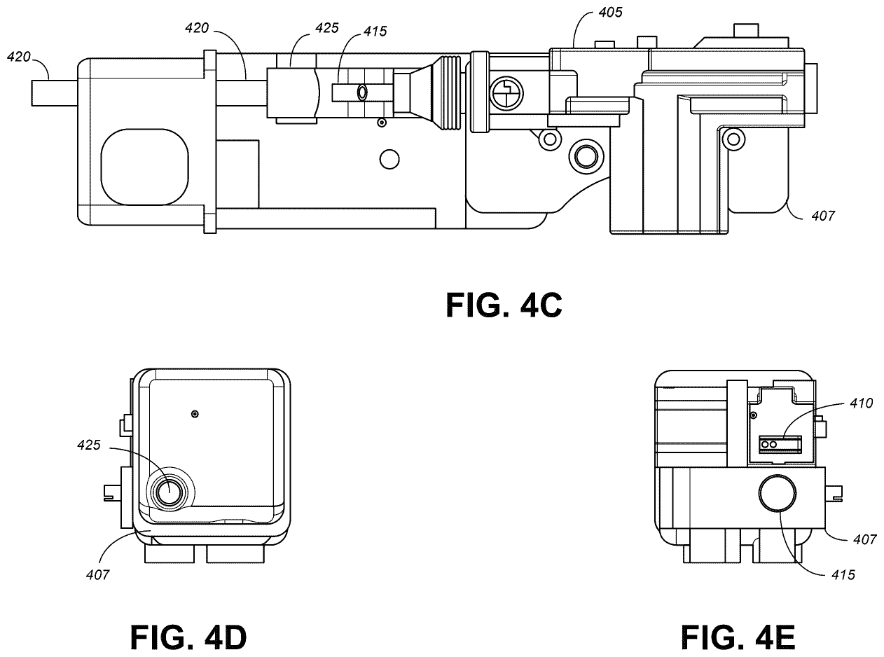

FIG. 4A, FIG. 4B, FIG. 4C, FIG. 4D, and FIG. 4E depict the locking mechanism 400 of the trailer lock in left-hand, right-hand, top, front, and back views in accordance with one or more embodiments. The locking mechanism includes an electric lock actuator 405 mounted on a locking body 407 and powered through electrical wiring 410. Power may be provided by the battery pack 310, shown in FIG. 3, or the electrical system of the tow vehicle (not shown). The battery pack 310 may also be kept charged by the electrical system of the tow vehicle.

The locking mechanism 400 furthermore includes a detention rod 415, a metal locking pin 420, and a coupling 425. Upon receipt of lock and unlock signals as described below, the electric lock actuator 405 drives the detention rod 415 through the coupling 425. The detention rod 415, in turn, drives the metal locking pin 420 in a reciprocating motion as indicated by the arrow 430. The metal locking pin 420 is driven forward, or toward the front, to lock and is driven backward, or toward the back, to unlock.

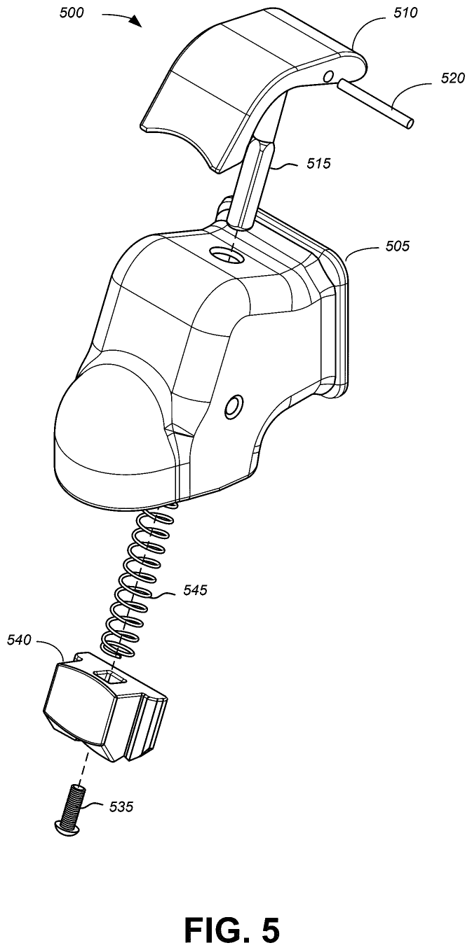

FIG. 5 depicts a sample coupler 500 as may be used in one or more examples. The coupler 500 includes a cast head coupler 505 to engage the ball (not shown) of a hitch. A top latch 510 coupled to a square clamp stem 515 by a pin 520 extends through an orifice 525 to engage a ball clamp 530. The engagement between the square clamp stem 515 and the ball clamp 530 is secured by a fastener 535 through a bore 540 through the body of the ball clamp 530. A biasing means 545, in this case a spring, biases the ball clamp 530 in an unclamped position until the bias is overcome by actuation of the top latch 510.

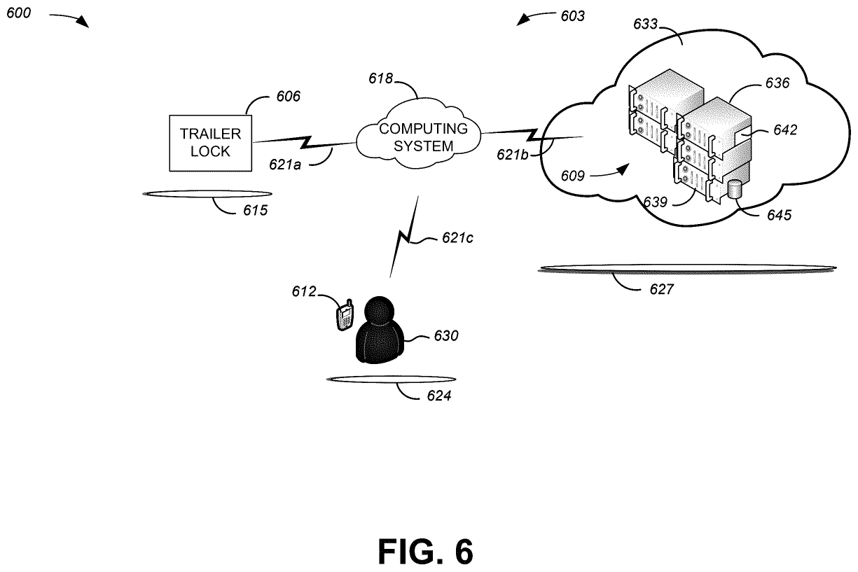

FIG. 6 depicts a scenario 600 in which the trailer lock of FIG. 1 may be implemented in a security system 603 according to one or more examples. In the scenario 600, the security system 603 includes a trailer lock 606, an off-trailer, cloud-based controller 609, and a remote device 612. The trailer lock 606 may be the trailer lock of FIG. 1 or another embodiment thereof. The scenario 600 includes not only the trailer lock 606, the cloud-based controller 609, and a remote device 612, but also a computing system 618. The trailer lock 606, the cloud-based controller 609, and a remote device 612 communicate with one another over the computing system 618, which includes the communications links 621a-621c.

The off-trailer, cloud-based controller 609 is hosted on one or more cloud computing systems 633 at a location 627. The cloud computing system(s) 633 include(s) a plurality of computing resources that have been allocated to the implementation of the presently disclosed technique. The allocated resources may include, for example, processes resources 636 and memory or storage resources 639. The off-trailer, cloud-based controller 609 may be implemented in a discrete programming construct 642 of some kind and may store data in a suitable data structure 645 in some embodiments.

The trailer lock 606 is located at what may be referred to as a “local” location 615, which is “local” because it is where the trailer (not shown) is located. The remote device 612 and the cloud-based controller 609 are at remote locations 624, 627, respectively, relative to the local location 615. As used herein, in one sense, the term “remote” means a physically different location than where the trailer lock 606 is located. In one sense, “remote” may mean that the geographical location is physically different from the “local” location. In a second sense, “remote” also means that the location is outside the physical presence of the trailer lock 606.

The remote device 612 may be any suitable computing device appropriately programmed to implement the functionality described herein. For example, the remote device 612 may be a smart phone or a tablet onto which an app has been downloaded. Or, the remote device 612 may be a workstation or desktop computer hosting an app or otherwise programmed. In some embodiments, the remote device may be a key fob programmed with microcode or some other form of machine language instructions.

The computing system 618 may be a private network, a public network, or a combination of private and public networks. Communications between the trailer lock 606, the cloud-based controller 609, and the remote device 612 may occur in part or as a whole over private and/or public networks of the computing system 618. In the illustrated embodiment, the computing system 618 is a cellular network such as may be used in cellular telephony. Cellular technology has the benefit of not relying on local networks, such as a WIFI® network and associated logistics associated with local connections (e.g., WIFI® and/or BLUETOOTH®) such as access points and passwords. However, not all embodiments are so limited and alternative wireless technologies may be employed in other embodiments.

In the interest of completeness, selected aspects of the trailer lock 606, the cloud-based controller 609, and the remote device 612 will now be discussed. In general, it is contemplated by the present disclosure that the trailer lock 606, the cloud-based controller 609, and the remote device 612, as well as any other computing device employed in the scenario 600, includes electronic components, software, and/or electronic computing devices operable to receive, transmit, process, store, and/or manage data and information associated performing the functions of the system as described herein. This contemplation encompasses any suitable processing device adapted to perform computing tasks consistent with the execution of computer-readable instructions stored in a memory or a computer-readable recording medium.

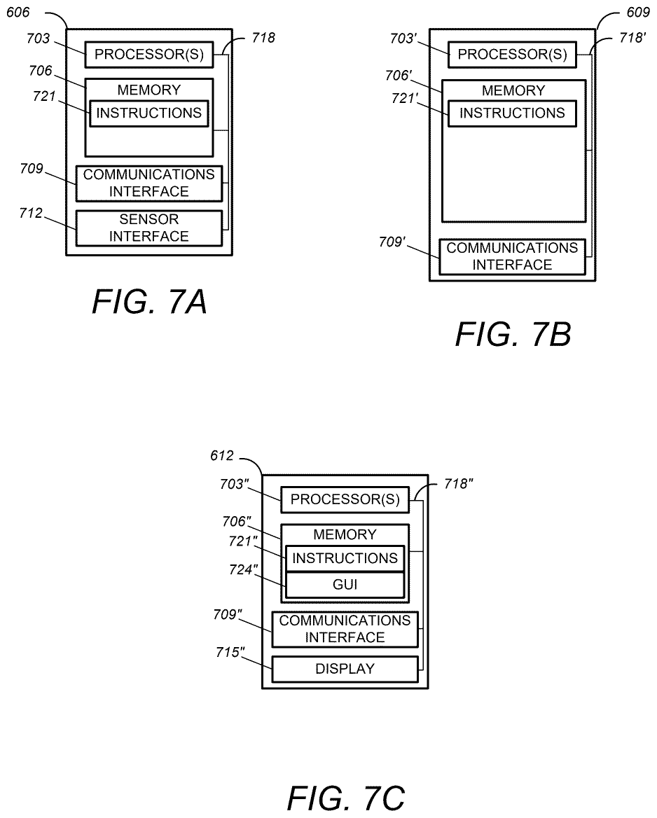

FIG. 7A, FIG. 7B, and FIG. 7C are block diagrams of selected aspects of the trailer lock 606, the cloud-based controller 609, and the remote device 612, respectively, first shown in FIG. 6.

The sensor interface 712 may be omitted in embodiments in which the trailer lock 606 does not sense or respond to alarms. In the embodiment of FIG. 6, the trailer lock 606 receives the data acquired by the sensors (not shown) through the sensor interface 712. The processors 703 execute the instructions 721 to transmit the acquired data in real time or near real time, through the execution of the instructions 721, transmit the sensed data off trailer using the communications interface 709.

However, some embodiments may employ one or more types of sensors for different purposes. Some embodiments may employ some type of positioning technology (e.g., Global Positioning System, or “GPS”) to monitor the position of the trailer lock and, hence, the trailer. If the trailer is not authorized to be moving, or has been stolen, accordingly to the GPS system, an alarm may be issued. Similarly, mileage and other parameters may be monitored for maintenance purposes. Operational characteristics may also be monitored, such as the position of the lock pin.

FIG. 7B shows the cloud-based controller 609, which includes one or more processors 703′, a memory 706′, and a communications interface 709′ all communicating over a bus system 718′. A set of instructions 721′ resides on the memory 706′. Sensed data (not shown) may be stored or buffered in any suitable data structure known to the art. Those in the art will appreciate that servers are relatively large capacity computing devices and so the cloud-based controller 609 may include many more computational resources than are shown in addition to those that are shown. Furthermore, those computational resources may be distributed across one or more devices or apparatuses.

FIG. 7C depicts the remote device 612. The remote device 612 includes one or more processors 703″, a memory 706″, a communications interface 709″, and a display 715″, all of which communicate with one another over a bus system 718″. A set of instructions 721″ and a GUI 724″ reside on the memory 706″. Execution of the instructions 721″ by the processor(s) 718″ imparts the functionality of the remote device 612, including interaction with a user 630, shown in FIG. 6, through the GUI 724″. The user 630 may also invoke (not shown) through the GUI 724″ to interact with the trailer lock 606 and the cloud-based controller 609.

Those in the art having the benefit of this disclosure will appreciate that the trailer lock 606, the cloud-based controller 609, and the remote device 612 may, and probably will, include other components. These other components may implement common functionalities, like a power source. For instance, a power source (not shown) may include a self-contained power source such as a battery pack and/or include an interface to be powered through an electrical outlet, either directly. The power source may also be a rechargeable battery that can be detached allowing for replacement. In the case of a rechargeable battery, a small built-in back-up battery (or super capacitor) can be provided for continuous power to be provided during battery replacement.

The trailer lock 606 of the illustrated embodiments includes a 12V battery (not shown) for a power source. In some embodiments, the battery is rechargeable. For example, the battery may be rechargeable through an electrical connection to the towing vehicle when the trailer is coupled to the towing vehicle for towing. Some embodiments may also recharge the battery from an external source, such as grid power, when desired.

Returning now to FIG. 6 and FIG. 7A-FIG. 7C collectively, the one or more processors 703, 703′, 703″ may be used for controlling the general operations of the respective device 606, 609, 612. The one or more processors 703, 703′, 703″ may be any suitable processor-based resource. They may be, but are not limited to, a central processing unit (“CPU”), a hardware microprocessor, a multi-core processor, a single core processor, a field programmable gate array (“FPGA”), a controller, a microcontroller, an application specific integrated circuit (“ASIC”), a digital signal processor (“DSP”), or other similar processing device capable of executing any type of instructions, algorithms, or software for controlling the operation and performing the functions of respective device 606, 609, 612. In some embodiments, the one or more processors 703, 703′, 703″ may comprise a processor chipset including, for example and without limitation, one or more co-processors.

The memories 706, 706′, 706″ may be single memory devices or one or more memory devices at one or more memory locations that may include, without limitation, one or more of a random-access memory (“RAM”), a memory buffer, a hard drive, a database, an erasable programmable read only memory (“EPROM”), an electrically erasable programmable read only memory (“EEPROM”), a read only memory (“ROM”), a flash memory, hard disk, various layers of memory hierarchy, or any other non-transitory computer readable medium. The memories 706, 706′, 706″ may be on-chip or off-chip depending on the implementation of the one or more processors 703, 703′, 703″.

The memories 706, 706′, 706″ may be used to store any type of instructions 721, 721′, 721″ associated with algorithms, processes, or operations for controlling the general functions and operations of the devices 212, 236, 239. The instructions 721, 721′, 721″ may be any form of software, including, without limitation, firmware, executable applications, etc. Execution of the instructions 721, 721′, 721″ by the respective one or more processors 703, 703′, 703″ will impart the functionalities of the devices 212, 236, 239 associated with the presently disclosed technique as discussed below.

The communications interfaces 709, 709′, 709″ may permit the respective network device 212, 236, 239 to directly or indirectly communicate with one or more computing networks and devices, workstations, consoles, computers, monitoring equipment, alert systems, and/or mobile devices (e.g., a mobile phone, tablet, or other hand-held display device). The communications interfaces 709, 709′, 709″ may include various network cards, interfaces, communication channels, cloud, antennas, and/or circuitry to permit wired and wireless communications with such computing networks and devices.

The communications interfaces 709, 709′, 709″ may be used to implement, for example, a BLUETOOTH® connection, a cellular network connection, and/or a WIFI® connection with such computing networks and devices. Example wireless communication connections implemented using the communication interfaces 709, 709′, 709″ include wireless connections that operate in accordance with, but are not limited to, IEEE802.11 protocol, a Radio Frequency For Consumer Electronics (“RF4CE”) protocol, and/or IEEE802.15.4 protocol (e.g., ZigBee® protocol). In essence, any wireless communication protocol may be used.

Additionally, the communications interfaces 709, 709′, 709″ may permit direct (i.e., device-to-device) communications (e.g., messaging, signal exchange, etc.) such as from, for example, a universal serial bus (“USB”) connection or other communication protocol interface. The communications interfaces 709, 709′, 709″ may also permit direct device-to-device connection to other devices such as to a tablet, computer, or similar electronic device; or to an external storage device or memory.

Those skilled in the art will appreciate that the implementation of the sensor interface 712 will turn strongly on sensors with which the trailer lock 606 interfaces. Different kinds of data collected by different kinds of sensors will typically be conditioned differently and, so, the implementation of the sensor interface 712 will differ. However, although not required, most implementations of the sensor interface 712 will include analog-to-digital conversion of the data. Furthermore, as discussed elsewhere, not all trailer lock embodiments will necessarily interface with sensors. Some embodiments therefore may omit a sensor interface.

Note that the various components of devices 606, 609, 612 may be implemented differently in any given embodiment. As a non-limiting example, in one embodiment the one or more processors 703 may be a single microprocessor while the one or more processors 703′ may be a processor chipset. Or, the memory 706 may be implemented in a single RAM device while the memory 706″ may be implemented in a redundant array of independent disks. Those in the art having the benefit of this disclosure will appreciate still other examples of differences in implementation-specific differences across embodiments.

In some embodiments, the processor-based resource of the trailer lock may be programmed to track sensed data regarding the operation of the of the trailer or the tow vehicle. The sensed data may be, or may include, maintenance data. The received alarm may be, in these embodiments, responsive to the sensed data regarding operations of the trailer and/or the tow vehicle.

The discussion above presents a number of acts in a certain order in accordance with a particular chronology. This is illustrative only and the order and chronology are not necessarily required or implemented in all embodiments. The method descriptions and the process flow diagrams set forth herein are provided merely as illustrative examples and are not intended to require or imply that the operations of the various embodiments must be performed in the order presented.

As will be appreciated by one of skill in the art having the benefit of this disclosure, the order of operations in the foregoing embodiments may be performed in any order. Words such as “thereafter,” “then,” “next,” etc. are not intended to limit the order of the operations; these words are simply used to guide the reader through the description of the methods. Exceptions may be found where the language describing the acts imposes such order. However, the mere order of presentation does not necessarily impose that order on the claimed subject matter.

Accordingly, in a first embodiment, a trailer lock comprises a locking mechanism and a programmable electronic trailer lock controller. a programmable electronic trailer lock controller, in turn, comprises a communications interface and a processor-based resource. The trailer lock controller receives lock and unlock signals to and from off-trailer through the communications interface. The processor-based resource programmed to issue lock and unlock controller commands to the locking mechanism responsive to received lock and unlock signals.

In a second embodiment, in the trailer lock of the first embodiment, the locking mechanism further comprises a lock slide, a lock pin, and an actuator. The actuator drives the lock pin to secure and release the lock slide from a locked position responsive to the control signals issued by the processor-based interface.

In a third embodiment, the trailer lock of the first embodiment comprises at least one sensor. The electronic trailer lock controller further includes a sensor interface and the processor-based sensor is further programmed to transmit sensor data off trailer through the communications interface.

In a fourth embodiment, in the trailer lock of the third embodiment, the electronic trailer lock controller receives an alarm through the communications interface, the alarm being responsive to the transmitted sensor data.

In a fifth embodiment, in the trailer lock of the third embodiment, the processor-based resource is programmed to track maintenance data and the sensed data is tracked maintenance data.

In an sixth embodiment, a method for use in locking a trailer connection comprises receiving an off-trailer signal to lock or unlock a locking mechanism structurally engaged with a trailer and issuing a lock or unlock controller command to the to the locking mechanism responsive to received lock and unlock signals.

In a seventh embodiment, the method of the sixth embodiment further comprises sensing data representative of the physical state of the trailer and transmitting the sensed data off trailer.

In an eighth embodiment, the method of the ninth embodiment further comprises receiving an off-trailer alarm, the alarm being responsive to the transmitted sensor data.

In a ninth embodiment, in the method of the seventh embodiment, the alarm indicates that a security condition has been violated and the method further comprises sending a command responsive to the security condition being violated.

In a tenth embodiment, a trailer security system comprises a trailer lock, a computing system, and an off-trailer, cloud-based controller. The off-trailer, cloud-based controller transmits lock and unlock signals to the trailer lock over the computing system.

In an eleventh embodiment, in the trailer security system of the tenth embodiment, wherein the trailer lock comprises the trailer lock of the first embodiment.

In a twelfth embodiment, in the trailer security system of the tenth embodiment, the computing system comprises a public network, a private network, or some combination thereof.

In a thirteenth embodiment, in the trailer security system of the tenth embodiment, the trailer lock includes at least one sensor and is programmed to transmit sensor data to the off-trailer, cloud-based controller over the computing system. The off-trailer, cloud-based controller is programmed to issue an alarm to the trailer lock over the computing system responsive to the received sensor data.

In an fourteenth embodiment, in the trailer security system of the thirteenth embodiment, the alarm indicates that the trailer lock is unlocked while the trailer lock is moving and the trailer lock locks response to the alarm.

In a fifteenth embodiment, the trailer security system of the tenth embodiment further comprises a remote device programmed to send lock and unlock signals to the trailer lock via the off-trailer, cloud-based controller and the computing system.

In a sixteenth embodiment, a method for securing a trailer comprises transmitting lock and unlock signals from an off-trailer, cloud-based controller to a trailer lock of the trailer and locking and unlocking a trailer lock of the trailer responsive to the lock and unlock signals.

In a seventeenth embodiment, in the method of the twentieth embodiment, transmitting the lock and unlock signals includes transmitting the lock and unlock signals over a public network, a private network, or some combination thereof.

In a eighteenth embodiment, the method of the sixteenth embodiment, further comprises: sensing data regarding the operation of the trailer; transmitting the sensed data from the trailer lock to the off-trailer, cloud-based controller; analyzing the received data by the off-trailer, cloud-based controller; and upon detecting an alarm condition, transmitting an alarm to the trailer lock.

In the nineteenth embodiment, the method of the sixteenth embodiment further comprises sensing data regarding the maintenance of the trailer and transmitting the sensed data from the trailer lock to the off-trailer, cloud-based controller.

In a twentieth embodiment, the method of the sixteenth embodiment further comprises transmitting the lock and unlock signals from a remote device to the off-trailer, cloud-based controller and transmitting the lock and unlock signals from the off-trailer, cloud-based controller to the trailer lock of the trailer comprises relaying the lock and unlock signals when received from the remote device.

In the disclosed embodiment, the mechanical coupling between the trailer and the towing vehicle is what may be characterized as a “ball and socket” coupling. More particularly, the towing vehicle is equipped with a ball hitch and a tongue on the trailer is equipped with a mating socket. This type of mechanical coupling is ubiquitous and so a good example for disclosing that which is sought to be protected. However, the claimed subject matter is not necessarily to be limited to such a coupling. It is to be understood that the claimed subject matter may be used in conjunction with other types of hitches upon suitable modification of the locking mechanism to accommodate different mechanical engagements in other kinds of couplings or hitches.

Some embodiments may be implemented as a program product for use with a computer system. The program(s) of the program product defines functions of the embodiments (including the methods described herein) and can be contained on a variety of computer-readable media. Illustrative computer-readable media include, but are not limited to: (i) information permanently stored on non-writable storage media (e.g., read-only memory devices within a computer such as CD-ROM disks readable by a CD-ROM drive); (ii) alterable information stored on writable storage media (e.g., floppy disks within a diskette drive or hard-disk drive); or (iii) information conveyed to a computer by a communications medium, such as through a computer or telephone network, including wireless communications. The latter embodiment specifically includes information to/from the Internet and other networks. Such computer-readable media, when carrying computer-readable instructions that direct the claimed functionalities may represent embodiments of the subject matter claimed below.

In general, the routines executed to implement the disclosed embodiments may be part of an operating system or a specific application, component, program, module, object, or sequence of instructions. The computer program(s) typically is/are comprised of a plurality of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment. However, it should be appreciated that any particular program nomenclature that herein is used merely for convenience, and thus the claimed subject matter should not be limited to use solely in any specific application identified and/or implied by such nomenclature.

Aspects presented in this disclosure may be embodied as a system, method or computer program product. Accordingly, aspects disclosed herein may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects disclosed herein may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this disclosure, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects disclosed herein may be written in any combination of one or more programming languages, including an object oriented programming language such as Java, Smalltalk, C++ or the like and conventional procedural programming languages, such as the “C” programming language or similar programming languages. The program code may execute entirely on the computer of a user, partly on the computer of the user, as a stand-alone software package, partly on the computer of the user and partly on a remote computer, or entirely on the remote computer or server. In the latter scenario, the remote computer may be connected to the computer of the user via any type of network, including a local area network (LAN) or a wide area network (WAN), or the connection may be made to an external computer (for example, through the Internet using an Internet Service Provider).

Aspects presented in this disclosure are described above with reference to flowchart illustrations or block diagrams of methods, apparatus (systems) and computer program products according to embodiments disclosed herein. It will be understood that each block of the flowchart illustrations or block diagrams, and combinations of blocks in the flowchart illustrations or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart or block diagram block or blocks.

Embodiments disclosed herein may be provided to end users through a cloud computing infrastructure. Cloud computing generally refers to the provision of scalable computing resources as a service over a network. More formally, cloud computing may be defined as a computing capability that provides an abstraction between the computing resource and its underlying technical architecture (e.g., servers, storage, networks), enabling convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources.

Typically, cloud computing resources are provided to a user on a pay-per-use basis, where users are charged only for the computing resources actually used (e.g. an amount of storage space consumed by a user or a number of virtualized systems instantiated by the user). A user can access any of the resources that reside in the cloud at any time, and from anywhere across the Internet. In context of the present disclosure, a user may access applications (e.g., enterprise system 102) or related data available in the cloud. For example, the enterprise system 102 could execute on one or more computing systems in the cloud and process transactions involving arbitrarily large data structures.

The flowchart and block diagrams in the Figures illustrate the architecture, functionality, and operation of possible implementations of systems, methods and computer program products according to various embodiments disclosed herein. In this regard, each block in the flowchart or block diagrams may represent a module, segment, or portion of code, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Each block of the block diagrams or flowchart illustration, and combinations of blocks in the block diagrams or flowchart illustration can be implemented by special-purpose hardware-based systems that perform the specified functions or acts, or combinations of special purpose hardware and computer instructions.

The terms “top” and “bottom” are defined relative to one another and relative to the ground surface and the force of gravity. Thus, the “top” will be that part or portion that faces away from the ground. “Bottom” will be that part or portion that faces toward the ground.

The terms “left”, “right”, “front”, and “back” are defined relative to the trailer's orientation relative to the towing vehicle (not shown). The “front” is the end of the trailer at which the tongue is located and where the trailer is coupled to the towing vehicle. The “back” is the end opposite the “front”. “Left” and “right” are defined as when facing the front of the trailer.

Expressions such as “include” and “may include” which may be used in the present disclosure denote the presence of the disclosed functions, operations, and constituent elements, and do not limit the presence of one or more additional functions, operations, and constituent elements. In the present disclosure, terms such as “include” and/or “have”, may be construed to denote a certain characteristic, number, operation, constituent element, component or a combination thereof, but should not be construed to exclude the existence of or a possibility of the addition of one or more other characteristics, numbers, operations, constituent elements, components or combinations thereof.

As used herein, the article “a” is intended to have its ordinary meaning in the patent arts, namely “one or more.” Herein, the term “about” when applied to a value generally means within the tolerance range of the equipment used to produce the value, or in some examples, means plus or minus 10%, or plus or minus 5%, or plus or minus 1%, unless otherwise expressly specified. Further, herein the term “substantially” as used herein means a majority, or almost all, or all, or an amount with a range of about 51% to about 100%, for example. Moreover, examples herein are intended to be illustrative only and are presented for discussion purposes and not by way of limitation.

As used herein, to “provide” an item means to have possession of and/or control over the item. This may include, for example, forming (or assembling) some or all of the item from its constituent materials and/or, obtaining possession of and/or control over an already-formed item.

Unless otherwise defined, all terms including technical and/or scientific terms used herein have the same meaning as commonly understood by one of ordinary skill in the art to which the present disclosure pertains. In addition, unless otherwise defined, all terms defined in generally used dictionaries may not be overly interpreted. In the preceding, details are set forth to provide a more thorough explanation of the embodiments. However, it will be apparent to those skilled in the art that embodiments may be practiced without these specific details. In other instances, well-known structures and devices are shown in block diagram form or in a schematic view rather than in detail in order to avoid obscuring the embodiments. In addition, features of the different embodiments described hereinafter may be combined with each other, unless specifically noted otherwise. For example, variations or modifications described with respect to one of the embodiments may also be applicable to other embodiments unless noted to the contrary.

Further, equivalent or like elements or elements with equivalent or like functionality are denoted in the preceding description with equivalent or like reference numerals. As the same or functionally equivalent elements are given the same reference numbers in the figures, a repeated description for elements provided with the same reference numbers may be omitted. Hence, descriptions provided for elements having the same or like reference numbers are mutually exchangeable.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

In the present disclosure, expressions including ordinal numbers, such as “first”, “second”, and/or the like, may modify various elements. However, such elements are not limited by the above expressions. For example, the above expressions do not limit the sequence and/or importance of the elements. The above expressions are used merely for the purpose of distinguishing an element from the other elements. For example, a first box and a second box indicate different boxes, although both are boxes. For further example, a first element could be termed a second element, and similarly, a second element could also be termed a first element without departing from the scope of the present disclosure.

A sensor refers to a component which converts a physical quantity to be measured to an electric signal, for example, a current signal or a voltage signal. The physical quantity may for example comprise electromagnetic radiation (e.g., photons of infrared or visible light), a magnetic field, an electric field, a pressure, a force, a temperature, a current, or a voltage, but is not limited thereto.

Use of the phrases “capable of,” “capable to,” “operable to,” “configured to,” or “programmed to” in one or more embodiments, refers to some apparatus, logic, hardware, and/or element designed in such a way to enable the use of the apparatus, logic, hardware, and/or element in a specified manner. Use of the phrase “exceed” in one or more embodiments, indicates that a measured value could be higher than a pre-determined threshold (e.g., an upper threshold), or lower than a pre-determined threshold (e.g., a lower threshold). When a pre-determined threshold range (defined by an upper threshold and a lower threshold) is used, the use of the phrase “exceed” in one or more embodiments could also indicate a measured value is outside the pre-determined threshold range (e.g., higher than the upper threshold or lower than the lower threshold). The subject matter of the present disclosure is provided as examples of apparatus, systems, methods, circuits, and programs for performing the features described in the present disclosure. However, further features or variations are contemplated in addition to the features described above. It is contemplated that the implementation of the components and functions of the present disclosure can be done with any newly arising technology that may replace any of the above-implemented technologies.

Various modifications to the disclosure will be readily apparent to those skilled in the art, and the generic principles defined herein may be applied to other variations without departing from the spirit or scope of the present disclosure. Throughout the present disclosure the terms “example,” “examples,” or “exemplary” indicate examples or instances and do not imply or require any preference for the noted examples. Thus, the present disclosure is not to be limited to the examples and designs described herein but is to be accorded the widest scope consistent with the principles and novel features disclosed.

This concludes the detailed description. The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed:

1. A trailer lock, comprising:
a locking mechanism; and
a programmable electronic trailer lock controller, comprising:
a communications interface through which the trailer lock controller receives lock and unlock signals to and from off-trailer; and
a processor-based resource programmed to issue lock and unlock controller commands to the locking mechanism responsive to received lock and unlock signals.

2. The trailer lock of claim 1, wherein the locking mechanism further comprises:
a lock slide;
a lock pin; and
an actuator that drives the lock pin to secure and release the lock slide from a locked position responsive to the control signals issued by the processor-based interface.

3. The trailer lock of claim 1,
further comprising at least one sensor; and
wherein:
the electronic trailer lock controller further includes a sensor interface; and
the processor-based sensor is further programmed to transmit sensor data off trailer through the communications interface.

4. The trailer lock of claim 3 wherein the electronic trailer lock controller receives an alarm through the communications interface, the alarm being responsive to the transmitted sensor data.

5. The trailer lock of claim 3, wherein the processor-based resource is programmed to track maintenance data, and the sensed data is tracked maintenance data.

6. A method for use in locking a trailer connection, comprising:
receiving an off-trailer signal to lock or unlock a locking mechanism structurally engaged with a trailer; and
issuing a lock or unlock controller command to the to the locking mechanism responsive to received lock and unlock signals.

7. The method of claim 6, further comprising:
sensing data representative of the physical state of the trailer; and
transmitting the sensed data off trailer.

8. The method of claim 7, further comprising receiving an off-trailer alarm, the alarm being responsive to the transmitted sensor data.

9. The method of claim 7,
wherein the alarm indicates that a security condition has been violated; and
the method further comprises sending a command responsive to the security condition being violated.

10. A trailer security system, comprising:
a trailer lock;
a computing system; and
an off-trailer, cloud-based controller that transmits lock and unlock signals to the trailer lock over the computing system.

11. The trailer security system of claim 10, wherein the trailer lock comprises the trailer lock of claim 1.

12. The trailer security system of claim 10, wherein the computing system comprises a public network, a private network, or some combination thereof.

13. The trailer security system of claim 10, wherein:
the trailer lock:
includes at least one sensor, and
is programmed to transmit sensor data to the off-trailer, cloud-based controller over the computing system; and
the off-trailer, cloud-based controller is programmed to issue an alarm to the trailer lock over the computing system responsive to the received sensor data.

14. The trailer security system of claim 13, wherein:
the alarm indicates that the trailer lock is unlocked while the trailer lock is moving; and
the trailer lock locks response to the alarm.

15. The trailer security system of claim 10, further comprising a remote device programmed to send lock and unlock signals to the trailer lock via the off-trailer, cloud-based controller and the computing system.

16. A method for securing a trailer, comprising:
transmitting lock and unlock signals from an off-trailer, cloud-based controller to a trailer lock of the trailer; and
locking and unlocking a trailer lock of the trailer responsive to the lock and unlock signals.

17. The method of claim 16, wherein transmitting the lock and unlock signals includes transmitting the lock and unlock signals over a public network, a private network, or some combination thereof.

18. The method of claim 16, further comprising:
sensing data regarding the operation of the trailer;
transmitting the sensed data from the trailer lock to the off-trailer, cloud-based controller;
analyzing the received data by the off-trailer, cloud-based controller; and
upon detecting an alarm condition, transmitting an alarm to the trailer lock.

19. The method of claim 16, further comprising:
sensing data regarding the maintenance of the trailer; and
transmitting the sensed data from the trailer lock to the off-trailer, cloud-based controller.

20. The method of claim 16,
further comprising transmitting the lock and unlock signals from a remote device to the off-trailer, cloud-based controller, and
transmitting the lock and unlock signals from the off-trailer, cloud-based controller to the trailer lock of the trailer comprises relaying the lock and unlock signals when received from the remote device.
